(19) United States
(12) Patent Application Publication
(10) Pub. No.: US 2014/0000155 A1
(43) Pub. Date: Jan. 2, 2014

(54) PROCESS FOR PURIFICATION OF BIODIESEL AND BIODIESEL OBTAINED BY SAID PROCESS

(71) Applicant: Arnaldo Curimbaba, Pocos de Caldas- MG (BR)

(72) Inventor: Arnaldo Curimbaba, Pocos de Caldas- MG (BR)

(21) Appl. No.: 13/989,685

(22) PCT Filed: Aug. 8, 2011
(86) PCT No.: PCT/BR2011/000264

§ 371 Date: Aug. 7, 2013

(30) Foreign Application Priority Data
Nov. 26, 2010 (BR) PI1005000-0

(51) Int. Cl. C10L 1/18

(52) U.S. Cl. CPC C10L 1/1802
USPC 44/307

(57) ABSTRACT

The present invention is directed to a process for biodiesel purification comprising the step of percolating biodiesel through a percolation system that comprises at least one percolation column comprising thermally activated bauxite and/or chemically activated bauxite. The present invention is further directed to a biodiesel obtained by said process.

### FIELD OF THE INVENTION

The present invention refers to a purification process of biodiesel and a biodiesel obtained by said process.

### BACKGROUND OF THE INVENTION

Biodiesel is a natural fuel and is considered a promising alternative to petroleum-based fuels. Being produced from renewable sources, emits fewer pollutants compared to conventional diesel. The production of biodiesel, renewable and biodegradable, from chemical reactions of oil has increased significantly.

At the end of the transesterification reaction to produce biodiesel, a liquid mixture consisting mostly of biodiesel (methyl or ethyl ester) and glycerin is obtained. In view of the difference in density of its components, this mixture is separated into decanters or through centrifuges.

Ester thus obtained is sent to a second reactor, where it is dried under vacuum, eliminating also traces of methanol or ethanol. Thus, biodiesel with a purity ranging from 90 to 95% is obtained.

However, the ester also contains small amounts of catalyst, glycerin and, depending on the raw material used, other non-triglycerides (fatty acids, fosfatidios, mono-glycerides, di-glycerides, waxes, rust, gum, mucilage, traces of proteins, sugars, moisture) impurities.

Catalyst, glycerol and non-triglycerides impurities should be removed, because the presence thereof reduces the purity of biodiesel and reduces the yield and efficiency of biodiesel use, and to meet the specifications required by the legislations of each country.

Some of the prior art documents already describe alternative processes for biodiesel purification, for example the following:

Document WO2009/099655 discloses a process for the continuous purification of raw biodiesel using an adsorbent contained in one or more columns and is regenerated for reuse multiple times. However, the adsorbent used is selected from the group comprising carbon, silica, clarifier clay, activated clarifier clay, and said adsorbent is a powder that is not used in percolation columns in view of the very low medium permeability. Further, the bauxite reactivation is effected by washing with a mixture of methanol and sulfuric acid.

Document de Paula et al (Utilização de argilas para purificaçã ode biodiesel, Quim. Nova, vol. 34, no 2, 91-95, 2001) describes a purification process comprising contacting with fine adsorbents (the adsorbent is mixed with biodiesel to be purified) and filtering. In this document, there is no teaching of process for separating the adsorbent and biodiesel and its possible recovery.

Document Caldas Jr, (Avaliação de reutilização da argila bentonitica na purificação do biodiesel, 2007) is directed to a process for biodiesel purification comprising mixing bentonite clay with impure biodiesel and then separating solid and liquid phases by filtering through filter paper, i.e. a contact process.

Document PI9901413-0 refers to a process for producing activated bauxite for use in purification methods comprising percolation and contact. This process aims at producing a spherical activated bauxite obtained from in natura bauxite intensely processed by grinding, pulverizing, pelletizing to form a spherical shape with the addition of high concentrations of ligands and modifying additives. The spherical pellets thus obtained are calcined, cooled and granulometrically classified to meet the required particle size range.

Document PI9805440-6 refers to a process developed for the purification of vegetable oils for food use in a percolation and contact system through activated bauxite.

Differently from the process for biodiesel purification of the present invention, the processes described in the prior art require several steps, results in environmental problems, high installation cost, high operating costs and, therefore, higher final cost. In sum, the process for biodiesel purification described in this patent application represents an improvement in the prior art and provides numerous advantages.

The innovative characteristic of the present invention is the use of thermally activated bauxite and/or chemically activated bauxite in order to reduce impurities in biodiesel. Such fact has not been reported in scientific or technology literature.

Therefore, it is an object of the present invention to provide a process for biodiesel purification capable of producing biodiesel with a high purity degree within the required specifications and does not present the drawbacks of known processes.

### SUMMARY OF THE INVENTION

The present invention relates to a process for biodiesel purification comprising the step of percolating biodiesel through a percolation system that comprises at least one percolation column comprising thermally activated bauxite and/or chemically activated bauxite.

Another embodiment of the present invention refers to the purified biodiesel obtained by the process described above.

### BRIEF DESCRIPTION OF DRAWINGS

FIG. 1 shows an illustrative flow chart of the process for biodiesel purification comprising the percolation of biodiesel through a percolation system (2) that comprises two percolation columns comprising thermally activated bauxite and/or chemically activated bauxite.

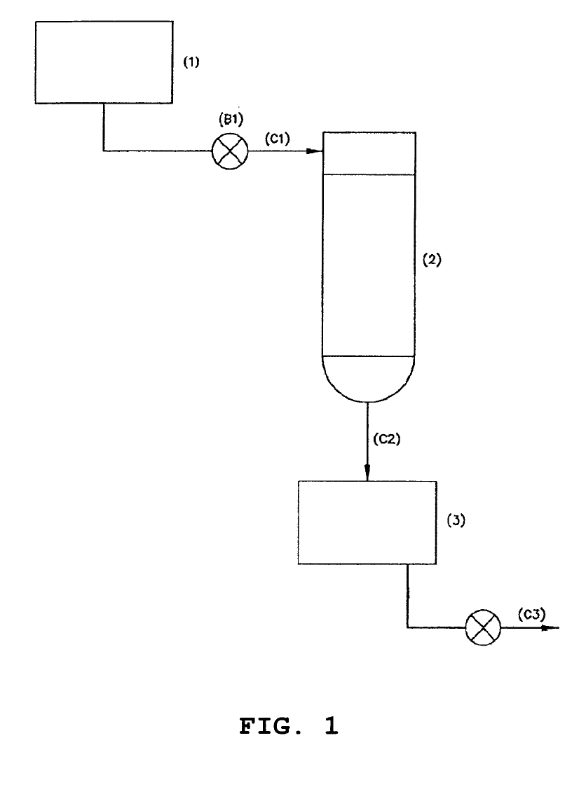

FIG. 2 shows an illustrative representation of a percolation system that comprises three percolation columns (3) comprising thermally activated bauxite and/or chemically activated bauxite and an auxiliary column (4) that also comprises thermally activated bauxite and/or chemically activated bauxite.

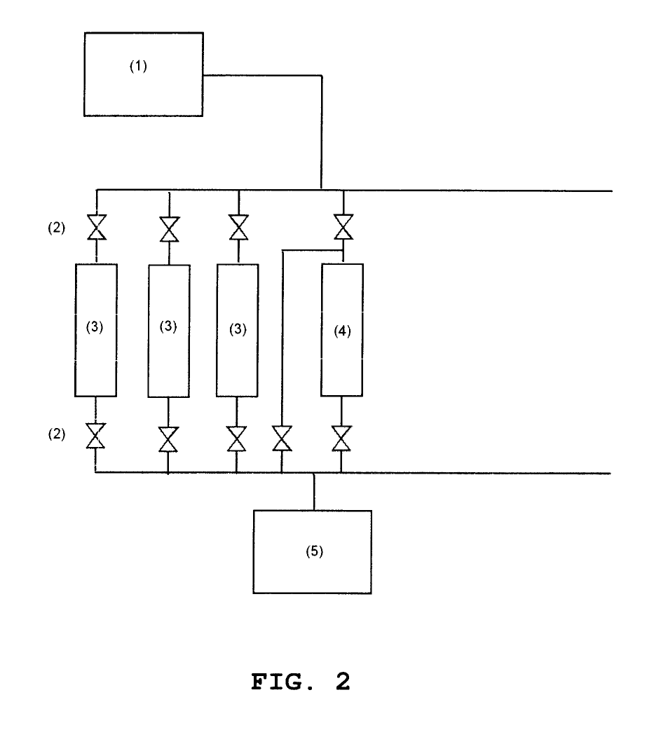

### DETAILED DESCRIPTION OF INVENTION

The process for biodiesel purification of the present invention comprises the step of percolating said biodiesel through a percolation system. The temperature and pressure of the percolating step through the system are properly adjusted.

Preferably, the percolation is carried out in a continuous form, which allows for greater time savings and significantly reduces losses during the process.

Through the purification process of the present invention, a biodiesel with a purity ranging from 94% to 100%, preferably 95% to 98% or more preferably from 96% to 98%, is obtained.

In a preferred embodiment of the present invention, the biodiesel to be purified is that obtained after the transesterification reaction and after the steps for glycerin separation.

Biodiesel useful in said process can be produced from vegetable oils, vegetable fats and/or animal fats, which can be purified, degummed, pre-purified, used and/or recycled.

The vegetable oils useful in the present invention are obtained from, but are not limited to, soybean (Glycine max (L.) Merrill), corn (Zea mays), cotton (Gossypium herbaceum, Gossypium arboreum, Gossypium barbadense, Gossypium hirsutum, among others), castor bean (Ricinus communis L.), peanut (Arachis hypogaea L.), sunflower (Helianthus annuus), rapeseed, palm, Acrocomia aculeata, Crambe abyssinica, Jatropha curcas L. and others.

With respect to animal fats, they comprise all those extracted from any land or aquatic animal, or birds, for example, but not limited to, cattle, pork, poultry and fish.

The percolation system used in process for biodiesel purification of the present invention comprises at least one percolation column comprising thermally activated bauxite and/or chemically activated bauxite.

The number of percolation columns present in the percolation system basically depends on the following: quality of the biodiesel to be purified, process flow, process plant capacity and level of purity of the purified biodiesel (i.e. product quality). In view of these variables and conditions, the number of columns comprising thermally activated bauxite and/or chemically activated bauxite can infinitely vary, each processing unit being designed specifically for each unit producing biodiesel.

A person skilled in the art having knowledge of these factors is capable of determining the number of percolation columns that the percolation system should have without excessive experimentation.

In a preferred embodiment, in order to maximize the quality of biodiesel to be purified and the purity of the purified biodiesel, the percolation system may comprise at least one auxiliary column comprising thermally activated bauxite and/or chemically activated bauxite. The auxiliary column assures the high quality of biodiesel obtained by the process of the present invention. An example of an auxiliary column is rectifier columns or Stand-by columns.

The thermally activated bauxite and/or chemically activated bauxite present in both the percolation column and in the auxiliary column presents a particle size range from 4 to 150 Mesh (4.75 to 0.106 mm), preferably from 10 to 60 Mesh (2 to 0.250 mm), and more preferably from 20 to 50 Mesh (0.850 to 0.300 mm).

In the same way of the number of percolation columns present in the percolation system, the volume of thermally activated bauxite and/or chemically activated bauxite present in the percolation column and in auxiliary column depends largely on the following: quality of the biodiesel to be purified, process flow, process plant capacity and level of purity of the purified biodiesel.

From the definition of these factors, the volume of thermally activated bauxite and/or chemically activated bauxite in the percolation column and in the auxiliary column can be determined by a person skilled in the art without excessive experiments, in a similar way to the number of percolation columns present in the percolation system.

In principle, any kind of bauxite can be used to obtain activated bauxite useful in the process for biodiesel purification of the present invention. Bauxite is a mixture of hydrated aluminum oxides of uncertain composition comprising accessory minerals including iron, silicon, titanium, sodium and potassium.

The main constituents of bauxite can be: gibbsite [Al(OH)₃], bohemita [AlO(OH)] and diaspore [HAlO₂]. The higher the content of Al₂O₃, the greater the possibilities of obtaining a bauxite with maximum activation. On the other hand, other components may be important to ensure the mechanical characteristics of the final product. Any bauxite can serve as a starting material for the manufacture of thermally activated bauxite and/or chemically activated bauxite, their quality does not limit the scope of this patent application.

The quality of the thermally activated bauxite and/or chemically activated bauxite used in the process of the present invention can widely vary, but preferably thermally activated bauxite and/or chemically activated bauxite having the chemical characteristics described in Table 1 is used:

TABLE 1
Chemical characteristics of thermally activated bauxite and/or
chemically activated bauxite used in the process for biodiesel
purification of the present invention

| Oxide | Content (%) |
|---|---|
| Al₂O₃ | 20 a 95 |
| Fe₂O₃ | 0.0 a 25.0 |
| TiO₂ | 0.0 a 6.0 |
| SiO₂ | 0.0 a 20.0 |
| Ignition loss | 0.0 a 6.0 |

More preferably, thermally activated bauxite and/or chemically activated bauxite shows the chemical composition described in Table 2.

TABLE 2
Preferably chemical characteristics of thermally activated bauxite
and/or chemically activated bauxite used in the process for
biodiesel purification of the present invention

| Oxide | Content (%) |
|---|---|
| Al₂O₃ | 56 a 80 |
| Fe₂O₃ | 9.0 a 16.0 |
| TiO₂ | 1.0 a 3.0 |
| SiO₂ | 3.0 a 12.0 |
| Ignition loss | 2.0 a 5.0 |

The processes for the thermal activation of the bauxite to be used in the process for biodiesel purification of the present invention are widely known from the state of art and the operating parameters can be readily determined by a person skilled in the art.

The thermally activated bauxites are products with absorptive and adsorptive characteristics used in the purification of oils, fats and paraffins, in the elimination of arsenic from drinking water, in the elimination of moisture, color and odor present in different products, in percolation or contact systems. Such products are known and industrially produced for a long time.

The adsorbents products most commonly used nowadays are: activated clay, silica, activated alumina and activated bauxite. The thermally activated bauxites are presented on the market in three different formats of grain: angular, spherical and cylindrical.

The angular format is known for some time. The spherical and extruded cylindrical bauxite are relatively recent known. All of these thermally activated bauxites are obtained from bauxite ore. The thermally activated bauxite in the angular format is generally obtained from the calcined, grounded and classified bauxite.

The spherical activated bauxite is obtained from a anqueous suspension of grounded and calcined (by spraying calciners type “flash”) bauxite, or by the use of pelletizers using dried and powdered bauxite. The extruded and activated bauxite is obtained from dried, grounded and extruded bauxite. Physically, the activation process of the bauxite comprises the calcination, and therefore the bauxite is well-known as thermally activated bauxite.

Good quality activated bauxite has a high adsorptive and absorptive capacities and, at the same time, provides a good mechanical strength.

In a preferred embodiment, the percolation system of the process for biodiesel purification further comprises an ignition combustion system (electrical or any flame). This combustion system initiates a combustion process, with controlled temperature, that burns the materials retained (glycerine, fatty acids, esters, water, contaminants). The temperature of said combustion process is from 200 to 1000° C., preferably from 400 to 800° C., more preferably from 500 to 700° C.

An exhaust system leads the combustion gases, including water vapor, through filters before releasing said combustion gases into the atmosphere. This reactivation process of bauxite can be repeated numerous times (with a minimum of 500 times). It requires only small additions of non-used thermally activated bauxite and/or chemically activated bauxite in order to replace possible losses in view of the exhaustion during the combustion.

The presence of this combustion system allows the complete reactivation, in the percolating system, of the thermally activated bauxite and/or chemically activated bauxite present in the at least one column after being used.

This feature makes the process for biodiesel purification of the present invention much more economical and feasible compared to those described in the prior art using natural clays or activated clays associated with filtration processes.

The fact that the thermally activated bauxite and/or chemically activated bauxite be recycled or reused in the process for biodiesel purification of the present invention, from the environmental point of view, makes this process much better compared to those described in the prior art.

Other advantages of the process for biodiesel purification of the present invention is the simplicity, there is no need for considerable movement of materials, the operation is easy and there is no environmental contamination.

The illustrative examples presented below serve to better describe the present invention. However, the data and procedures illustrated refer merely to some embodiments of the present invention and should not be taken as limiting the scope of it.

### Example 1

Biodiesel B100, initially stored in a tank (1), was continuous percolated with a flow of 60 L/h through a percolation system (2) comprising two jacketed percolation columns. Each of these percolation columns comprises 50 kg of thermally activated bauxite having the following characteristics:

TABLE 3
Chemical characteristics of thermally activated bauxite used in the
process for biodiesel purification in Example 1.
Chemical Analysis

| | | | |
|---|---|---|---|
| Al₂O₃ = 76.4% | SiO₂ = 9.19% | Fe₂O₃ = 11.3% | TiO₂ = 1.34% |

Mesh Sizes

| | | |
|---|---|---|
| >#20 = 0.00% | <#20 (0.850 mm); >#50 | Mean diameter = 0.573 mm |
| | (0.300 mm) = 99.7% | |

Other Characteristics

| | |
|---|---|
| Azobenzene adsortion = 26.0% | Abrasion loss = 9.14% |
| Moisture = 2.27% | Density = 1.00 g/cm3 |

The process for biodiesel purification was carried out at room temperature, around 20 to 25° C. overnight and peaking at 35° C. during the day. The temperature of the biodiesel which supplied the columns was always above 20° C. and the temperature inside the column was from 23 to 30° C. The maximum differential pressures were not higher than 1.5 kg/cm².

The results obtained concerning the moisture, acidity and total contamination reduction are shown in Table 4.

TABLE 4
results obtained by the process of Example 1

| | | | Acidity | Total |
|---|---|---|---|---|
| | Time | Moisture | (mg de KOH/ | contamination |
| Batch | (min) | (mg/kg) | g) | (mg/kg) |
| 1 | 0 | 380 | 0.22 | 27.6 |
| | 60 | 150 | <0.1 | 2.7 |
| | 120 | 130 | <0.1 | 2.6 |
| 2 | 0 | 360 | 0.21 | 21.4 |
| | 60 | 80 | 0.03 | 11.6 |
| | 120 | 90 | <0.7 | 1.1 |
| 3 | 0 | 340 | 0.22 | 23.1 |
| | 60 | 70 | 0.09 | 4.3 |
| | 120 | 110 | 0.09 | 1.8 |

### Example 2

Biodiesel B100, initially stored in a tank (1), was continuous percolated with a flow of 120 L/h through a percolation system (2) comprising two jacketed percolation columns. Each of these percolation columns comprises 50 kg of thermally activated bauxite having the following characteristics:

TABLE 5
Chemical characteristics of thermally activated bauxite used in the
process for biodiesel purification in Example 2.
Chemical Analysis

| | | | |
|---|---|---|---|
| Al₂O₃ = 76.4% | SiO₂ = 9.19% | Fe₂O₃ = 11.3% | TiO₂ = 1.34% |

Mesh Sizes

| | | |
|---|---|---|
| >#20 = 0.00% | <#20 (0.850 mm); >#50 | Mean diameter = 0.573 mm |
| | (0.300 mm) = 99.7% | |

Other Characteristics

| | |
|---|---|
| Azobenzene adsortion = 26.0% | Abrasion loss = 9.14% |
| Moisture = 2.27% | Density = 1.00 g/cm3 |

The process for biodiesel purification was carried out at room temperature, around 20 to 25° C. overnight and peaking at 35° C. during the day. The temperature of the biodiesel which supplied the columns was always above 20° C. and the temperature inside the column was from 23 to 30° C. The maximum differential pressures were not higher than 1.5 kg/cm².

The results obtained concerning the moisture, acidity and total contamination reduction are shown in Table 6.

TABLE 6
results obtained by the process of Example 2

| | | | Acidity | Total |
|---|---|---|---|---|
| | Time | Moisture | (mg de KOH/ | contamination |
| Batch | (min) | (mg/kg) | g) | (mg/kg) |
| 1 | 0 | 340 | 0.22 | 23.1 |
| | 60 | 70 | <0.1 | 4.3 |
| | 120 | 110 | <0.1 | 1.8 |
| 2 | 0 | 390 | nd | nd |
| | 60 | 110 | 0.10 | 1.9 |
| | 120 | 90 | <0.1 | 6.1 |
| 3 | 0 | 290 | nd | nd |
| | 60 | 100 | 0.14 | 0.1 |
| | 120 | 80 | 0.15 | 1.8 |

The biodiesel obtained by the purification process described in the examples above is totally free of sludge, soap, monoglycerides, diglicerideoos and triglicerideoos, and meets all required parameters of the legislations of ANP (National Petroleum Agency).

In the two examples, through an analysis of the results, a reduction in the level of original impurities, represented by moisture, acidity and total contamination, is observed. So, the great capacity of the present process for biodiesel purification is clearly observed.

The moisture should be reduced to the maximum, because the water is separated from the biodiesel and sink to the bottom of the fuel tanks, causing the development of organic waste, damaging the performance of the engines and causing jamming thereof. The European and American standards for biodiesel limit the water content to a maximum of 500 mg/kg.

The acid index indicates deterioration of fuel, causes corrosion and deposits in the engine, the standards, including the Brazilian standard, establishes a maximum value for this parameter of 0.50 mg KOH/g.

The Brazilian and European standards establish the total contamination in biodiesel must be at a maximum of 24 mg/kg, this contamination refers to the insoluble material present in the product.

1. A process for biodiesel purification comprising percolating biodiesel from at least one of a vegetable oil, a vegetable fat, and an animal fat through a percolation system, the percolation system comprising:
at least one percolation column comprising at least one of thermally activated bauxite and chemically activated bauxite;
at least one auxiliary column comprising at least one of thermally activated bauxite and chemically activated bauxite; and
an ignition combustion system, wherein the at least one of thermally activated bauxite and chemically activated bauxite has a particle size range from 4 to 150 mesh or 4.75 mm to 0.106 mm;
wherein the ignition combustion system comprises:

| Oxide | Content (%) |
|---|---|
| Al₂O₃ | 20 to 95 |
| Fe₂O₃ | 0.0 to 25.0 |
| TiO₂ | 0.0 to 6.0 |
| SiO₂ | 0.0 to 20.0 |
| Ignition loss | 0.0 to 6.0 |

and wherein the ignition combustion system has a temperature of combustion of 200° C. to 1000° C.

2. The process according to claim 1 wherein the percolation is carried out in a continuous form.

3. (canceled)

4. The process according to claim 2 wherein the auxiliary column is a rectifier column or a stand-by column.

5.-9. (canceled)

10. A biodiesel obtained by a process according to claim 1.

11. A biodiesel obtained by a process according to claim 2.

12. A biodiesel obtained by a process according to claim 2.

13. A process for biodiesel purification comprising percolating biodiesel from at least one of a vegetable oil, a vegetable fat, and an animal fat through a percolation system, the percolation system comprising:
at least one percolation column comprising at least one of thermally activated bauxite and chemically activated bauxite;
at least one auxiliary column comprising at least one of thermally activated bauxite and chemically activated bauxite;
and an ignition combustion system, wherein the at least one of thermally activated bauxite and chemically activated bauxite has a particle size range from 4 to 150 mesh (4.75 to 0.106 mm); wherein the ignition combustion system comprises 20% to 95% aluminum oxide, 0% to 25% ferric oxide, 0% to 6% titanium dioxide, and 0% to 20% silicon dioxide; wherein the ignition combustion system has an ignition loss of 0% to 6%, and wherein the ignition combustion system has a temperature of combustion of 200° C. to 1000° C.;
to obtain a biodiesel.
